(19) United States
(12) Patent Application Publication
(10) Pub. No.: US 2021/0080875 A1
(43) Pub. Date: Mar. 18, 2021

(54) IMAGE FORMING APPARATUS

(71) Applicant: TOSHIBA TEC KABUSHIKI KAISHA, Tokyo (JP)

(72) Inventor: Suguru KURITA, Sunto Shizuoka (JP)

(73) Assignee: TOSHIBA TEC KABUSHIKI KAISHA, Tokyo (JP)

(21) Appl. No.: 16/574,818

(22) Filed: Sep. 18, 2019

(51) Int. Cl. G03G 15/16; G03G 17/08; G03G 15/30

(52) U.S. Cl. CPC G03G 15/1645; G03G 15/30; G03G 17/08

(57) ABSTRACT

An image forming apparatus includes a detection unit and a control unit. The control unit controls a photoreceptor application unit and a development application unit such that a surface potential of a photoreceptor, which is applied by a photoreceptor application unit, is temporarily lower than a development potential which is applied by a development application unit and controls the photoreceptor application unit or the development application unit based on an adhesion amount of the developer, which is detected by the detection unit.

### FIELD

Embodiments described herein relate generally to an image forming apparatus.

### BACKGROUND

An image forming apparatus may perform dedicated processing to stabilize image quality. In such dedicated processing, toner is transferred to a transfer belt, and an adhesion amount of the transferred toner is detected. Based on the detected adhesion amount, a feedback control is performed to stabilize the image quality.

Since the dedicated processing is different from image forming processing performed according to instruction of a user, the dedicated processing may cause the performance of the image forming apparatus to deteriorate or otherwise wear prematurely.

Some image forming apparatus perform processing to stabilize image quality as the image forming processing starts, to prevent the performance from deteriorating. The image forming apparatus transfers toner during a rise of charging bias and development bias (e.g., voltage biases), and the image forming apparatus measures an adhesion amount of the transferred toner.

During the rise of the charging bias and the development bias, a potential difference between the charging bias and the development bias may vary. In this case, a carrier may adhere to the toner. If the carrier adheres to the toner, it becomes difficult to accurately measure the adhesion amount of the toner. As a result of an inaccurate measurement of the toner in the dedicated processing, accurate feedback control cannot be performed and the image quality cannot be stabilized.

### DESCRIPTION OF THE DRAWINGS

FIG. 1 is an external view illustrating an example of an overall configuration of an image forming apparatus according to an embodiment;

FIG. 2 is a diagram illustrating an example of an internal configuration of the image forming apparatus;

FIG. 3 is a diagram illustrating an example of a configuration of a printer;

FIG. 4 is a graph illustrating a change of charging bias and development bias;

FIG. 5 is a graph illustrating a change of charging bias, and development bias; and

FIG. 6 is a sequence diagram illustrating a flow of a detection control.

### DETAILED DESCRIPTION

In general, according to one embodiment, an image forming apparatus includes a photoreceptor application unit, a developing unit, a development application unit, an intermediate transfer body, a transfer unit, a detection unit, and a control unit. The photoreceptor application unit applies a potential to a surface of a photoreceptor on which an electrostatic latent image is formed. The developing unit develops the electrostatic latent image formed on the photoreceptor using a developer. The development application unit applies a potential to the developing unit. To the intermediate transfer body, the developer used in development of the developing unit to the photoreceptor is transferred. The transfer unit transfers the developer used in development to the photoreceptor to the intermediate transfer body. The detection unit detects the adhesion amount of the developer transferred to the intermediate transfer body by the transfer unit. The control unit controls the photoreceptor application unit and the development application unit such that a surface potential of the photoreceptor, which is applied by the photoreceptor application unit, is temporarily lower than a development potential which is applied by the development application unit and controls the photoreceptor application unit or the development application unit based on the adhesion amount of the developer, which is detected by the detection unit.

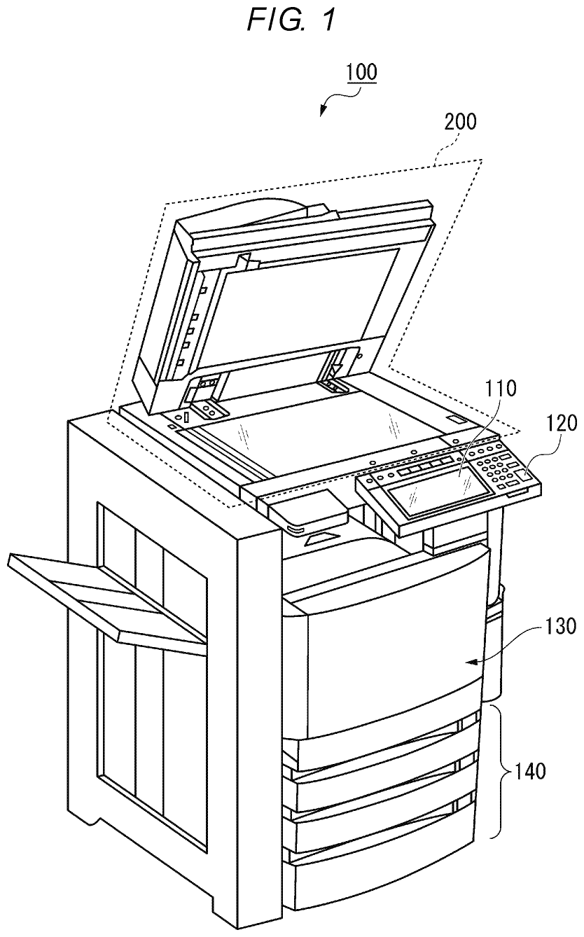

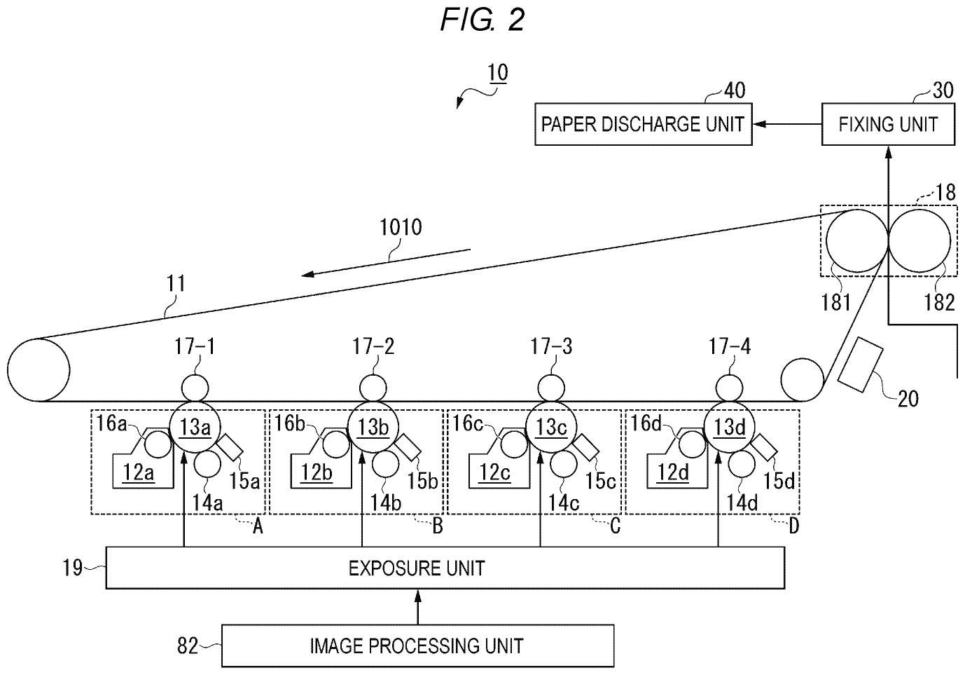

FIG. 1 illustrates an external view of an example of an overall configuration of an image forming apparatus 100 according to an embodiment. The image forming apparatus 100 is, for example, a multifunction peripheral. The image forming apparatus 100 includes a display 110, a control panel 120, a printer 130, a sheet storage unit 140, and an image reading unit 200. In addition, the image forming apparatus 100 includes a control unit 101 that controls a whole apparatus as illustrated in FIG. 2. The image forming apparatus 100 forms an image on a sheet using a developer. The developer is, for example, a toner. In the following description, the developer is described as a toner. The sheet is, for example, paper or label paper. The sheet may be anything as long as the image forming apparatus 100 can form an image on a surface thereof.

The display 110 is an image display device such as a liquid crystal display or an organic electro luminescence (EL) display. The display 110 displays various types of information on the image forming apparatus 100.

The control panel 120 includes a plurality of buttons. The control panel 120 receives an operation of a user. The control panel 120 outputs a signal corresponding to the operation performed by the user to the control unit 101 of the image forming apparatus 100. The display 110 and the control panel 120 may be configured as an integral touch panel.

The printer 130 prints an image on the sheet, based on image information generated by the image reading unit 200 or image information received via a network. The printer 130 prints an image using the toner. The sheet on which an image is printed may be a sheet stored in the sheet storage unit 140, or may be a handed sheet.

The sheet storage unit 140 stores a sheet used for image formation in the printer 130.

The image reading unit 200 reads information of an image to be read as light and dark of light. The image reading unit 200 records the read image information. The recorded image information may be transmitted to another information processing apparatus via a network. The recorded image information may be formed as an image on the sheet by the printer 130.

FIG. 2 illustrates a diagram of an example of an internal configuration of the image forming apparatus 100. In the example of FIG. 2, the image forming apparatus 100 is a quadruple tandem type image forming apparatus. However, the image forming apparatus 100 does not need to be limited to the quadruple tandem type.

The image forming apparatus 100 includes an image forming unit 10, an adhesion amount sensor 20, a fixing unit 30, and a paper discharge unit 40. The image forming unit 10 includes an intermediate transfer body 11, developing devices A to D, a plurality of primary transfer rollers 17 (17-1 to 17-4), a secondary transfer unit 18, and an exposure unit 19. The primary transfer roller 17 is an example of the transfer unit.

The intermediate transfer body 11 maybe configured using, for example, an endless belt. The intermediate transfer body 11 is rotated by a roller in the direction of an arrow 1010. In the present embodiment, upstream and downstream are defined based on a direction in which the intermediate transfer body 11 moves. Visible images generated by the developing devices A to D are transferred to a surface of the intermediate transfer body 11.

The developing devices A to D form visible images respectively using toners having different properties. For example, in some developing devices, toners having different colors respectively may be used. As the toners having different colors, toners of each color of yellow (Y), magenta (M), cyan (C), and black (K) maybe used. For example, in some developing devices, toners that lost color due to an external stimulus (such as heat) may be used. For example, in some developing devices, special toners such as glossy toners and fluorescent toners may be used. In FIG. 2, the developing device A is located most upstream among the four developing devices, and the developing device D is located most downstream among the four developing devices.

The developing devices A to D are different in properties of the toner to be used, but configurations thereof are the same as each other. The developing device A includes a developing unit 12a, a photoreceptor drum 13a, a charger 14a, a cleaning blade 15a, and a developing drum 16a. The developing device B includes a developing unit 12b, a photoreceptor drum 13b, a charger 14b, a cleaning blade 15b, and a developing drum 16b. The developing device C includes a developing unit 12c, a photoreceptor drum 13c, a charger 14c, a cleaning blade 15c, and a developing drum 16c. The developing device D includes a developing unit 12d, a photoreceptor drum 13d, a charger 14d, a cleaning blade 15d, and a developing drum 16d.

In the following description, if each of the developing units 12a, 12b, 12c, and 12d is not particularly distinguished, the developing units will be expressed as a developing unit 12. Similarly, if each of the photoreceptor drums 13a, 13b, 13c, and 13d is not particularly distinguished, the photoreceptor drums will be expressed as a photoreceptor drum 13.

Similarly, if each of the chargers 14a, 14b, 14c, and 14d is not particularly distinguished, the chargers will be expressed as a charger 14. Similarly, if each of the cleaning blades 15a, 15b, 15c, and 15d is not particularly distinguished, the cleaning blades will be expressed as a cleaning blade 15. Similarly, if each of the developing drums 16a, 16b, 16c, and 16d is not particularly distinguished, the developing drums will be expressed as a developing drum 16.

Hereinafter, the developing devices will be described using the developing device A as an example. The developing device A includes the developing unit 12a, the photoreceptor drum 13a, the charger 14a, the cleaning blade 15a, and the developing drum 16a.

The developing unit 12a contains the toner and a carrier. The developing unit 12a causes the toner to adhere to the photoreceptor drum 13a by the developing drum 16a.

The photoreceptor drum 13a has a photoreceptor (a photosensitive area) on an outer peripheral surface. The photoreceptor is, for example, an organic photoconductor (OPC). The photoreceptor drum 13a is exposed by the exposure unit 19 and an electrostatic latent image is formed on a surface thereof.

The charger 14a uniformly charges the surface of the photoreceptor drum 13a.

The cleaning blade 15a is, for example, a plate-like member. The cleaning blade 15a is formed of, for example, a rubber such as a urethane resin. The cleaning blade 15a removes the toner adhering on the photoreceptor drum 13a.

Next, an outline of an operation of the developing device A will be described. The photoreceptor drum 13a is charged to a predetermined potential by the charger 14a. Next, the photoreceptor drum 13a is irradiated with light from the exposure unit 19. Accordingly, the potential of an area of the photoreceptor drum 13a, irradiated with light, changes. Due to this change, an electrostatic latent image is formed on the surface of the photoreceptor drum 13a. The electrostatic latent image on the surface of the photoreceptor drum 13a is developed using the toner of the developing unit 12a. That is, a visible image, which is an image developed using the toner, is formed on the surface of the photoreceptor drum 13a.

The primary transfer rollers 17 (17-1 to 17-4) transfer the visible images formed on the photoreceptor drum by the developing devices A to D to the intermediate transfer body 11.

The secondary transfer unit 18 includes a secondary transfer roller 181 and a secondary transfer counter roller 182. The secondary transfer unit 18 collectively transfers the visible images formed on the intermediate transfer body 11 to a sheet targeted for image formation. The transfer of the secondary transfer unit 18 is realized, for example, by a potential difference between the secondary transfer roller 181 and the secondary transfer opposing roller 182.

The exposure unit 19 forms the electrostatic latent image by irradiating the photoreceptor drums of developing devices A to D with light. The exposure unit 19 includes a light source such as a laser or a light emitting diode (LED).

The adhesion amount sensor 20 is provided to detect the adhesion amount of the toner on the intermediate transfer body between the development device D located at the most downstream and the secondary transfer unit 18. The adhesion amount sensor 20 maybe configured using, for example, an optical sensor. The adhesion amount sensor 20 is an example of the detection unit.

The fixing unit 30 fixes the visible images onto the sheet by heating and pressing the visible images transferred onto the sheet.

The paper discharge unit 40 discharges the sheet on which the visible image is fixed by the fixing unit 30.

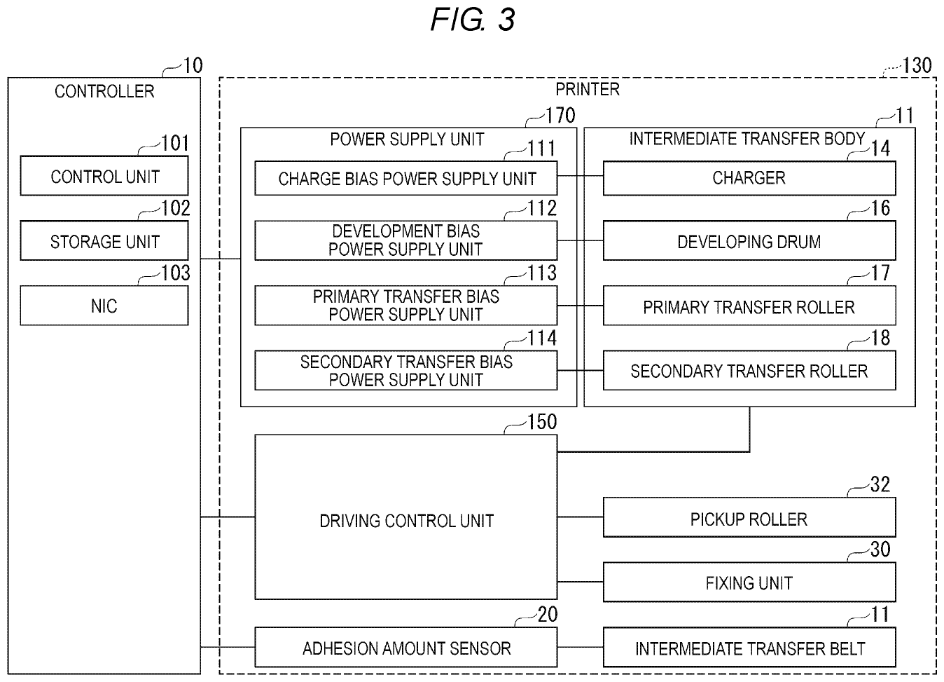

FIG. 3 illustrates a diagram of an example of a configuration of the printer 130. The printer 130 is controlled by a controller 10.

The controller 10 includes the control unit 101, a storage unit 102, and a network interface card (NIC) 103. The control unit 101 is an arithmetic processing unit. The control unit 101 executes a program stored in the storage unit 102 to control each part in the image forming apparatus 100 to print desired information on the sheet. The storage unit 102 includes a volatile storage device and a non-volatile storage device. The volatile storage devices include a random access memory (RAM). The non-volatile storage devices include a read only memory (ROM), a hard disk drive (HDD), or a solid state drive (SSD). The storage unit 102 stores a program of processing to be executed by the control unit 101. The storage unit 102 stores various data such as constants, tables, and adjustment patterns used for the processing. The constants include a standard value applied to an initial value of the processing. The NIC 103 controls communication with an outside.

A drive control unit 150 adjusts a drive amount of each driving unit in the image forming apparatus 100. For example, a control target of the drive control unit 150 includes each roller (not illustrated) used in intermediate transfer, a pickup roller 32, and a roller of the fixing unit 30.

A power supply unit 170 supplies a desired bias by the control of the control unit 101. The power supply unit 170 includes a charge bias power supply unit 111, a development bias power supply unit 112, a primary transfer bias power supply unit 113, and a secondary transfer bias power supply unit 114. The control unit 101 is an example of the control unit.

The charge bias power supply unit 111 supplies a charge bias to the charging device 14 such that a surface of the photoreceptor drum 13 is charged.

The development bias power supply unit 112 supplies a development bias to the development drum 16 of the development unit 12.

The primary transfer bias power supply unit 113 supplies a bias to the primary transfer roller 17. The primary transfer bias power supply unit 113 adjusts the transfer bias by varying a voltage of the bias according to the control by the control unit 101.

The secondary transfer bias power supply unit 114 supplies a bias to the secondary transfer unit 18. The secondary transfer bias power supply unit 114 includes a constant voltage source and a constant current source. The secondary transfer bias power supply unit 114 can select whether the bias is supplied in a constant voltage system or a constant current system by control of the control unit 101. If the bias is supplied with the constant voltage system, in the secondary transfer bias power supply unit 114, a voltage value is specified from the control unit 101 and a bias of the specified voltage value is supplied. If a bias is supplied with the constant current system, in the secondary transfer bias power supply unit 114, a current value is specified from the control unit 101 and a bias of the specified current value is supplied. As described above, the secondary transfer bias power supply unit 114 adjusts the transfer bias by varying a voltage or a current of the bias according to the control of the control unit 101.

The charger 14 and the charge bias power supply unit 111 are examples of the photoreceptor application unit. The development drum 16 and the development bias power supply unit 112 are examples of the development application unit.

Next, detection control of detecting the adhesion amount of the toner by controlling surface potential to be temporarily lower than the development potential when starting the image formation or ending the image formation will be described.

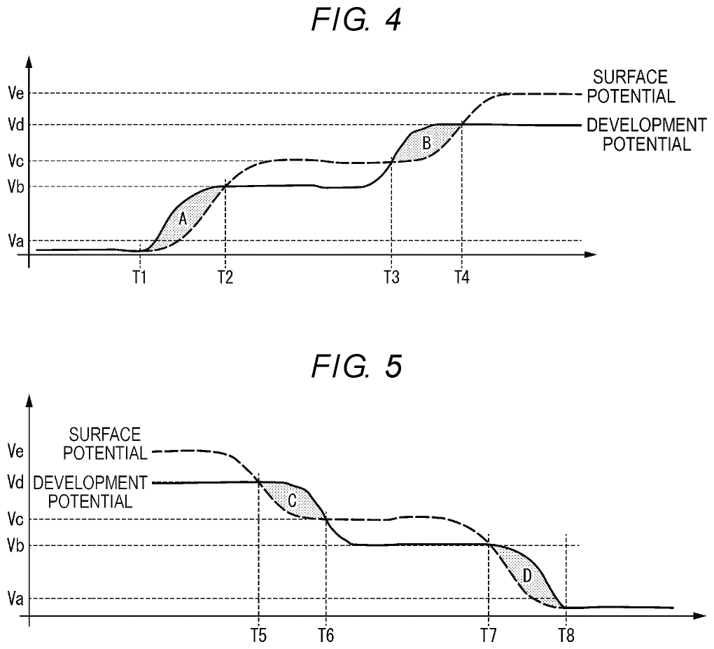

FIGS. 4 and 5 illustrate graphs illustrating a change of the bias. In FIGS. 4 and 5, a horizontal axis shows a passage of time, and a vertical axis shows the potential. FIG. 4 illustrates a graph illustrating the change of the bias in the detection control when starting the image formation. Specifically, FIG. 4 illustrates the change in bias that rises when starting the image formation by instruction or the like of a user. FIG. 5 illustrates a graph illustrating the change of the bias in the detection control when ending the image formation. Specifically, FIG. 5 illustrates the change of the bias lowered after the image formation by the instruction or the like of the user ends. As described above, the detection control is performed not in a control executed by dedicated processing, but performed along with the image formation and thus integrated with normal use. Therefore, the performance of the image forming apparatus 100 does not deteriorate or otherwise wear prematurely due to potential adjustments or related maintenance performed in the conventional dedicated processing.

In FIGS. 4 and 5, a solid line indicates the potential of the developing drum 16 (hereinafter, also referred to as “development potential”), and a broken line indicates the surface potential of the photoreceptor drum 13. Ve indicates a final target potential of the surface potential when performing the image forming processing. Vd indicates a final target potential of the development potential when performing the image forming processing. Vc indicates an intermediate target potential of the surface potential. Vb indicates an intermediate target potential of the development potential. Va indicates the surface potential when exposed.

In general, if the charge bias and the development bias are raised, the image forming apparatus first raises the development bias before the charged portion of the surface on the photoreceptor drum 13 facing the charger 14 reaches the developing unit 12.

At this time, if the development bias is relatively high, carrier may also adhere to the belt together with the toner in some cases. As such, the adhesion amount sensor 20 may not accurately measure an amount of toner adhered to the belt.

Thus, as illustrated in FIG. 4, the controller 10 temporarily raises the development potential and the surface potential respectively to the intermediate target potentials Vb and Vc. Thereafter, the controller 10 raises the development potential and the surface potential respectively to the final target potentials Vd and Ve. Accordingly, adhesion of the carrier can be suppressed.

When the controller 10 temporarily raises the potentials to the intermediate target potentials Vb and Vc, the controller 10 controls the charge bias power supply unit 111 and the development bias power supply unit 112 such that the surface potential becomes temporarily lower than the development potential during the timing T1 to the timing T2.

Accordingly, a toner image is formed on the photoreceptor drum 13 in the area A illustrated in FIG. 4.

Thereafter, when the controller 10 raises the potentials to the final target potentials Vd and Ve, the controller 10 controls the charge bias power supply unit 111 and the development bias power supply unit 112 such that the surface potential becomes temporarily lower than the development potential during the timing T3 to the timing T4.

Accordingly, a toner image is formed on the photoreceptor drum 13 in an area B illustrated in FIG. 4. As illustrated in FIG. 4, the controller 10 controls the charge bias power supply unit 111 and the development bias power supply unit 112 such that the surface potential becomes temporarily lower than the development potential plural times. Vc and Ve are examples of the first potential. Vb and Vd are examples of the second potential.

Although approximate Vd-Vc may be adopted as a development contrast in the areas A and B, the controller 10 can estimate the development contrast.

For example, examples of an estimation method in the area A includes a method in which the controller 10 estimates the surface potential and the development potential from an environment such as temperature and humidity, a lifetime of the image forming apparatus 100, and the time elapsed from the previous image formation, and potential difference therebetween is used as the development contrast.

In addition, examples of an estimation method in the area B includes a method in which the controller 10 estimates the surface potential and the development potential from Vb, Vc, and Ve, and the potential difference therebetween is used as the development contrast, in addition to the estimation method for the area A.

The controller 10 controls the charge bias power supply unit 111 or the development bias power supply unit 112 based on the development contrast and the adhesion amount of the toner detected by the adhesion amount sensor 20.

Specifically, the development contrast in the area A is set as P, and the detected adhesion amount is set as Q. In addition, the development contrast in the area B is set as S, and the detected adhesion amount is set as T. In this case, it is considered that a relationship between a development contrast Y and an adhesion amount X can be approximated by the following equation.

Y=(Q−T)/(S−T)×(X−P)+Q

Accordingly, since the adhesion amount X and the development contrast Y correspond to each other on a one-to-one basis, the development contrast Y is uniquely determined from the desired adhesion amount X. The controller 10 controls the charge bias power supply unit 111 or the development bias power supply unit 112 to obtain the development contrast Y, thereby being possible to obtain the adhesion amount X. The controller controls the charge bias power supply unit 111 or the development bias power supply unit 112 based on the adhesion amount of the developer transferred plural times, detected by the adhesion amount sensor 20.

Next, FIG. 5 will be described. As described above, FIG. 5 illustrates the change of the bias lowered after the image formation by the instruction or the like of the user ends.

If the image formation ends, the controller 10 temporarily lowers the development potential and the surface potential respectively to the intermediate target potentials Vb and Vc. Thereafter, the controller 10 lowers the development potential and the surface potential respectively to the lowest potentials lower than Va.

When the controller 10 temporarily lowers the potentials to the intermediate target potentials Vb and Vc, the controller 10 controls the charge bias power supply unit 111 and the development bias power supply unit 112 such that the surface potential becomes temporarily lower than the development potential during the timing T5 to the timing T6.

Accordingly, a toner image is formed on the photoreceptor drum 13 in an area C illustrated in FIG. 5.

Thereafter, when the controller 10 lowers the potentials to the lowest potentials, the controller 10 controls the charge bias power supply unit 111 and the development bias power supply unit 112 such that the surface potential becomes temporarily lower than the development potential during the timing T7 to the timing T8.

Accordingly, a toner image is formed on the photoreceptor drum 13 in an area D illustrated in FIG. 5. As illustrated in FIG. 5, the controller 10 controls the charge bias power supply unit 111 and the development bias power supply unit 112 such that the surface potential becomes temporarily lower than the development potential plural times.

Although approximate Vd-Vc may be adopted as the development contrast in the areas C and D, the controller 10 can estimate the development contrast using the estimation method described above.

The controller 10 controls the charge bias power supply unit 111 or the development bias power supply unit 112 based on the development contrast and the adhesion amount of the toner detected by the adhesion amount sensor 20. In this case, the control is the same as the control described in FIG. 4.

The controller 10 may control the exposure unit 19, a parameter relating to image formation, and an image formation position, based on the adhesion amount of the toner detected by the adhesion detection sensor 20.

Examples of the control of the exposure unit 19 include a control of exposure power. Examples of the parameter relating to image formation include a parameter relating to a screen shape, a pattern, and the like for determining a half tone. Examples of the control of the image forming position include control of correcting deviations in a main scanning direction and a sub-scanning direction.

For example, if the image forming timing of the developing devices A to D deviates, a deviation in the main scanning direction occurs. If the deviation occurs in the main scanning direction, the adhesion amount of toner decreases but an adhesion area becomes longer in the main scanning direction. If the adhesion amount sensor 20 detects such an event, the controller 10 controls the image forming timing based on the detection of the adhesion amount sensor 20.

The deviation in the sub-scanning direction can be detected by using the adhesion amount sensor 20 as a line sensor parallel to the sub-scanning direction. If the deviation in the sub-scanning direction occurs, the adhesion amount of toner decreases but an adhesion area becomes longer in the sub-scanning direction. If the adhesion amount sensor 20 detects such an event, the controller 10 controls the image forming timing based on the detection of the adhesion amount sensor 20.

If the deviations in the main scanning direction and the sub-scanning direction are corrected, a binary output sensor configured to detect only whether or not toner adheres may be used, instead of the adhesion amount sensor 20. This is because the binary output sensor can detect that the area to which the toner adheres becomes longer in the sub-scanning direction.

As illustrated in FIGS. 4 and 5, a carrier can be prevented from adhering by providing a plurality of target potentials and performing control to raise or lower the potential stepwise.

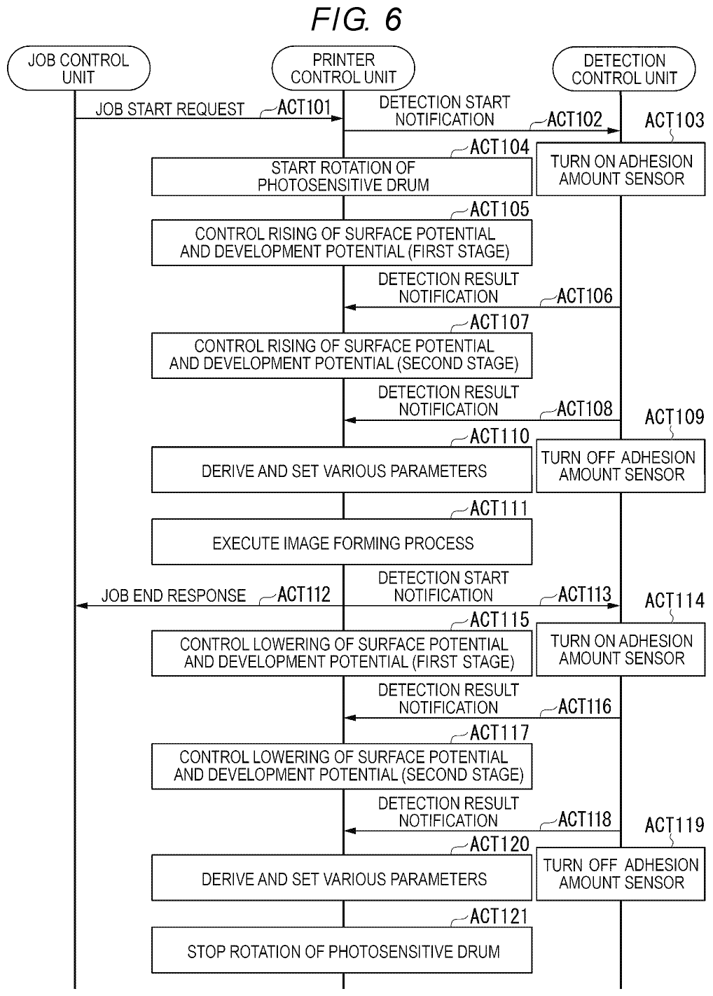

Next, a flow of detection control will be described using a sequence diagram. FIG. 6 illustrates a sequence diagram illustrating a flow of a detection control executed by software in the controller 10. Here, as an example, a flow of control by each task of a job control unit, a print control unit, and a detection control unit is illustrated. The printer control unit is an example of the control unit.

The detection control unit in FIG. 6 controls the adhesion amount sensor 20. The print control unit controls the printer 130. The job control unit gives instructions to receive a job and execute the job. For example, the job control unit accepts start of image formation by an instruction or the like of the user, and instructs the print control unit and the like to form an image.

In FIG. 6, if an instruction for image formation is input by the user, the job control unit sends a job start request to the print control unit (ACT101). If the print control unit receives the job start request, the print control unit sends a detection start notification to the detection control unit (ACT102). If the detection control unit receives the detection start notification, the detection control unit turns on the adhesion amount sensor 20 (ACT103). Thus, the adhesion amount sensor 20 starts to detect the adhesion amount of the developer until the electrostatic latent image is formed on the photoreceptor drum 13 in ACT111 after the charge bias power supply unit 111 or the development bias power supply unit 112 starts to apply the potential.

The print control unit starts rotation of the photoreceptor drum 13 (ACT104), and controls the development potential and the surface potential to rise respectively to the intermediate target potentials Vb and Vc (ACT105). In this case, as described above, the development bias before the charged portion of the surface on the photoreceptor drum 13 facing the charger 14 reaches the developing unit 12 is first raised.

The detection control unit sends a detection result notification illustrating the adhesion amount of the toner detected by the adhesion amount sensor 20 to the print control unit (ACT106). Here, notification of a detection result in the area A is performed. The print control unit controls the development potential and the surface potential to rise respectively to the final target potentials Vd and Ve (ACT107).

The detection control unit sends a detection result notification to the print control unit (ACT108) and turns off the adhesion amount sensor 20 (ACT109). Here, notification of a detection result in the area B is performed. The print control unit derives various parameters from the adhesion amount indicated in the detection result notification received in a first stage and a second stage, and sets the parameters (ACT110). Accordingly, since the parameters are immediately reflected on the image formation, the image quality can be improved. The various parameters are, for example, parameters relating to a relationship between an adhesion amount X and a development contrast Y.

The print control unit executes image forming processing instructed by the user (ACT111). If the image forming processing ends, the printer control unit sends the job end response to the job control unit (ACT112), and sends detection start notification to the detection control unit (ACT113). If the detection control unit receives the detection start notification, the detection control unit turns on the adhesion amount sensor (ACT114). In this manner, the adhesion amount sensor 20 starts to detect the adhesion amount of the developer until the charge bias power supply unit 111 or the development bias power supply unit 112 ends the application of the potential after the formation of the electrostatic latent image on the photoreceptor drum 13 in ACT111 ends.

The print control unit controls the development potential and the surface potential to lower respectively to the intermediate target potentials Vb and Vc (ACT115). The detection control unit sends a detection result notification illustrating the adhesion amount of the toner detected by the adhesion amount sensor 20 to the print control unit (ACT116). Here, notification of a detection result in the area C is performed. The print control unit controls the development potential and the surface potential to lower respectively to the lowest potentials (ACT117).

The detection control unit sends a detection result notification to the print control unit (ACT118) and turns off the adhesion amount sensor 20 (ACT119). Here, notification of a detection result in the area D is performed. The print control unit derives various parameters from the adhesion amount indicated in the detection result notification received in the first stage and the second stage, and sets the parameters (ACT120). The printer control unit stops the rotation of the photoreceptor drum 13 (ACT121) and ends processing. The various parameters of ACT120 are, for example, parameters relating to a relationship between the adhesion amount X and the development contrast Y.

In the sequence diagram, detection control is executed at both raising and lowering, but maybe executed at either raising or lowering. For example, if the detection control is executed only during lowering and the parameters are set in ACT120, the parameters can be reflected in the next image formation. Accordingly, the image quality can be improved even if the detection control is performed only during lowering.

In the related art, detection control is executed if images are formed on a certain number of sheets. The certain number is, for example, 1,000 sheets. In this case, since the control is performed by estimation based on a drive count of the photoreceptor drum or the like and an environmental change or the like until the certain number is reached, it is difficult to stabilize the image quality with high accuracy.

On the other hand, in the detection control according to the present embodiment, since the control can be performed each time the image formation is performed, the image quality can be stabilized with high accuracy and high frequency compared to the related art.

In the embodiment, the bias is controlled in two stages, but the bias maybe controlled in one stage or three more stages. If there are three or more stages, three or more sets of the development contrast and the detected adhesion amount are obtained. If the three or more sets are obtained, the least squares method may be used to determine an approximate expression.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus comprising:
a photoreceptor application unit configured to apply a potential to a surface of a photoreceptor on which an electrostatic latent image is to be formed;
a developing unit configured to develop the electrostatic latent image formed on the photoreceptor using a developer;
a development application unit configured to apply a potential to the developing unit;
an intermediate transfer body configured to receive the developer used in development of the developing unit;
a transfer unit configured to transfer the developer from the intermediate transfer body;
a detection unit configured to detect an adhesion amount of the developer transferred to the intermediate transfer body by the transfer unit; and
a control unit configured to control the photoreceptor application unit and the development application unit such that a surface potential of the photoreceptor, which is applied by the photoreceptor application unit, is temporarily lower than a development potential which is applied by the development application unit and control the photoreceptor application unit or the development application unit based on the adhesion amount of the developer, which is detected by the detection unit.

2. The apparatus according to claim 1, wherein
when the control unit raises the surface potential of the photoreceptor to a first potential and raises the potential applied to the developing unit to a second potential lower than the first potential, the control unit controls the photoreceptor application unit and the development application unit such that the surface potential is temporarily lower than the development potential.

3. The apparatus according to claim 2, wherein
when the control unit raises the surface potential of the photoreceptor to the first potential and raises the potential applied to the developing unit to the second potential lower than the first potential, the control unit controls the photoreceptor application unit and the development application unit such that the surface potential is temporarily lower than the development potential plural times, and
the detection unit detects the adhesion amount of the developer transferred plural times to the intermediate transfer body.

4. The apparatus according to claim 3, wherein
the control unit controls the photoreceptor application unit or the development application unit based on the adhesion amount of the developer, detected plural times by the detection unit.

5. The apparatus according to claim 1, further comprising:
an exposure unit configured to form an electrostatic latent image on the photoreceptor, wherein
the detection unit starts to detect the adhesion amount of the developer until the exposure unit forms the electrostatic latent image on the photoreceptor after the photoreceptor application unit or the development application unit starts to apply the potential.

6. The apparatus according to claim 1, wherein
when the control unit lowers the surface potential of the photoreceptor from a first potential and lowers the potential applied to the developing unit from a second potential lower than the first potential, the control unit controls the photoreceptor application unit and the development application unit such that the surface potential is temporarily lower than the development potential.

7. The apparatus according to claim 6, wherein
when the control unit lowers the surface potential of the photoreceptor from the first potential and lowers the potential applied to the developing unit from the second potential lower than the first potential, the control unit controls the photoreceptor application unit and the development application unit such that the surface potential is temporarily lower than the development potential a plurality of times, and
the detection unit detects a plurality of times the adhesion amount of the developer transferred to the intermediate transfer body.

8. The apparatus according to claim 7, wherein
the control unit controls the photoreceptor application unit or the development application unit based on the adhesion amount of the developer, detected plural times by the detection unit.

9. The apparatus according to claim 6, further comprising:
an exposure unit configured to form an electrostatic latent image on the photoreceptor, wherein
the detection unit starts to detect the adhesion amount of the developer until the photoreceptor application unit or the development application unit ends application of the potential after the exposure unit ends formation of the electrostatic latent image on the photoreceptor.

10. The apparatus according to claim 1, further comprising:
an exposure unit configured to form an electrostatic latent image on the photoreceptor, wherein
the control unit controls the exposure unit, a parameter relating to image formation, and an image formation position, based on the adhesion amount of the developer detected by the detection unit.

11. A method for stabilizing image quality without causing additional wear to an image forming apparatus, the method comprising:
providing, in a photoreceptor, a surface potential variable in time, wherein providing the surface potential includes:
providing the surface potential at an intermediate surface potential lower than a final surface potential in a first period of time,
providing the surface potential at the final surface potential in a second period of time, and
providing the surface potential at the intermediate surface potential in a third period of time; and
providing, in the photoreceptor, a development potential variable in time, wherein providing the development potential includes:
providing the development potential at an intermediate development potential lower than a final development potential in the first period of time,
providing the development potential at the final development potential in the second period of time, and
providing the development potential at the intermediate development potential in the third period of time;
wherein the surface potential rises after the development potential in the first period of time, rises after the development potential in the second period of time, decreases after the development potential in the second period of time, and decreases after the development potential in the third period of time.

12. The method of claim 11, wherein a difference between the surface potential and the development potential forms an image on a medium when the surface potential decreases and is lower than the development potential.

13. The method of claim 12, wherein the image is formed during the second period of time and the third period of time.

14. The method of claim 11, further comprising detecting an amount of developer adhered to an intermediate transfer body; and determining a development contrast based on the detected amount of developer adhered to the intermediate transfer body.

15. The method of claim 14, wherein:
the development potential is temporarily greater than the surface potential in the first period of time for a first subset period of time and forms a first cumulative value (P) of a difference between the development potential and the surface potential in the first subset period of time; and
the development potential is temporarily greater than the surface potential in the second period of time fora second subset period of time and forms a second cumulative value (S) of a difference between the development potential and the surface potential in the second subset period of time.

16. The method of claim 15, further comprising:
detecting a first amount of developer (Q) adhered to the intermediate transfer body in the first subset period of time;
detecting a second amount of developer (T) adhered to the intermediate transfer body in the second subset period of time; and
determining a development contrast (Y) based on an adhesion amount (X), wherein Y=(Q−T)/(S−T)×(X−P)+Q.

17. The method of claim 16, further comprising:
adjusting the development contrast and forming an forming an image on a medium in the second and the third periods of time.

18. A method for simultaneously forming an image in an image forming apparatus and adjusting development contrast in the image forming apparatus, the method comprising:
controlling a first rising of a surface potential and a first rising of a development potential in a first stage, wherein the development potential rises earlier and is greater than the surface potential in the first stage;
controlling a second rising of the surface potential and a second rising of the development potential in a second stage, wherein the development potential rises earlier and is greater than the surface potential in the second stage;
measuring an adhesion amount of developer in the first stage and the second stage;
determining a development contrast based on the measured adhesion amount of the developer; and
setting parameters for image formation based on the development contrast.

19. The method of claim 18, further comprising:
controlling a first lowering of the surface potential and a first lowering of the development potential in a third stage, wherein the development potential decreases later and is greater than the surface potential in the third stage;
controlling a second lowering of the surface potential and a second lowering of the development potential in a fourth stage, wherein the development potential decreases later and is greater than the surface potential in the fourth stage; and
forming an image using the set parameters based on the development contrast via a difference between the development potential and the surface potential in the third stage and in the fourth stage.

20. The method of claim 19, further comprising:
measuring an adhesion amount of developer in the third stage and the fourth stage; and
deriving parameters for image formation based on the measured adhesion amount in the third stage and fourth stage.
